(19) United States
(12) Patent Application Publication
(10) Pub. No.: US 2026/0106234 A1
(43) Pub. Date: Apr. 16, 2026

(54) POWER RECEIVING APPARATUS, BATTERY UNIT, ELECTRIC POWER UNIT, AND WORK MACHINE

(71) Applicant: HONDA MOTOR CO., LTD., Tokyo (JP)

(72) Inventors: Norio Kaneko, Wako-shi (JP); Yasuhiro Nakada, Wako-shi (JP); Takayuki Enomoto, Wako-shi (JP); Toru Yuki, Wako-shi (JP)

(73) Assignee: HONDA MOTOR CO., LTD., Tokyo (JP)

(21) Appl. No.: 19/259,392

(22) Filed: Jul. 3, 2025

Related U.S. Application Data
(63) Continuation of application No. 17/712,603, filed on Apr. 4, 2022, now abandoned.
Application No. 17/712,603 is a continuation of application No. PCT/JP2019/040294, filed on Oct. 11, 2019.

(51) Int. Cl. H01M 10/42; H01M 50/204; H01M 50/247; H02J 7/50; H02J 7/80

(52) U.S. Cl. CPC H01M 10/425; H01M 50/204; H01M 50/247; H02J 7/575; H02J 7/80; H01M 2220/30

(57) ABSTRACT

One aspect of an invention is a power receiving apparatus, configured to be able to receive electric power from a plurality of battery units each including a processor configured to control a power feeding function, the power receiving apparatus comprising a plurality of connection portions capable of electrically connecting the plurality of battery units, wherein the plurality of connection portions are configured such that voltages supplied to the plurality of processors of the plurality of battery units have different values when the plurality of battery units are electrically connected to the connection portions

### CROSS-REFERENCE TO RELATED APPLICATION(S)

This application is a continuation of U.S. patent application Ser. No. 17/712,603 filed on Apr. 4, 2022, which is a continuation of International Patent Application No. PCT/JP2019/040294 filed on Oct. 11, 2019, the entire disclosure of which is incorporated herein by reference.

### TECHNICAL FIELD

The present invention mainly relates to a power receiving apparatus and a battery unit.

### BACKGROUND ART

Patent Literature 1 describes the configuration of an electric work machine (electric tool) in which a plurality of battery units (battery packs) are individually electrically connected. A work machine body includes a plurality of connection portions configured to electrically connect the plurality of battery units.

### CITATION LIST

### Patent Literature

PTL1: Japanese Patent Laid-Open No. 2011-161603

### SUMMARY OF INVENTION

### Technical Problem

In general, any battery unit may be electrically connected to the plurality of connection portions described above. That is, the battery unit detached from the work machine body can be optionally replaced with another battery unit having a similar configuration. In such a configuration, it is conceivable that a processor configured to control the power feeding function of each battery unit is mounted on the battery unit. In order to achieve the appropriate control of the power feeding function, it may be necessary for the processor to appropriately detect which of the plurality of connection portions the battery unit is electrically connected to. Therefore, a technique for achieving this with a relatively simple configuration is required.

An exemplary object of the present invention is to provide a power receiving apparatus and a plurality of battery units electrically connectable to the power receiving apparatus, in which the appropriate control of the power feeding function of each of the battery units is achieved with a relatively simple configuration.

### Solution to Problem

A first aspect of the present invention relates to a power receiving apparatus. The power receiving apparatus is configured to be able to receive electric power from a plurality of battery units each including a processor configured to control a power feeding function. The power receiving apparatus includes a plurality of connection portions capable of electrically connecting the plurality of battery units. The plurality of connection portions are configured such that voltages supplied to the plurality of processors corresponding to the plurality of battery units have different values when the plurality of battery units are electrically connected to the connection portions.

### Advantageous Effects of Invention

The present invention makes it possible to achieve the appropriate control of the power feeding function of each battery unit.

### BRIEF DESCRIPTION OF DRAWINGS

FIG. 1 is a block diagram illustrating a configuration example of an electric work machine.

FIG. 2 is a circuit block diagram illustrating a configuration example of a battery unit and a power receiving apparatus.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### (Configuration Example of Work Machine)

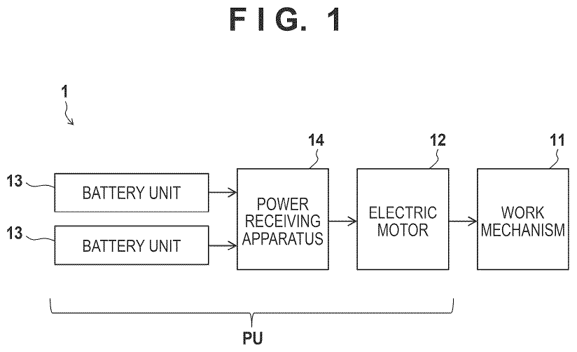

FIG. 1 is a block diagram illustrating a system configuration example of a work machine 1 according to an embodiment. The work machine 1 is an electric work machine (for example, a trowel or a sweeper or the like) that includes a work mechanism 11, an electric motor 12, a battery unit 13, and a power receiving apparatus 14, to cause the work mechanism 11 to perform predetermined work using the electric power of the battery unit 13.

The work mechanism 11 executes the above-described work based on motive power (rotation) generated by the electric motor 12. The battery unit 13 is configured to be able to store electric power. In the present embodiment, a plurality of battery units are arranged in parallel. The power receiving apparatus 14 incorporates a power drive unit (PDU) or the like, converts electric power received from the battery unit 13 into a predetermined mode, and supplies the electric power to the electric motor 12.

Here, the electric motor 12 is illustrated as an electric power supply target, but the work machine 1 may further include an electric device such as a display device or a light source device as other electric power supply target.

The configuration of the work machine 1 is not limited to the above-described example, and various modifications may be made within a range that does not departing from the gist thereof. The electric motor 12, the battery unit 13, and the power receiving apparatus 14 may be unitized separately from the work mechanism 11, and thus can be used in various applications as an electric power unit PU.

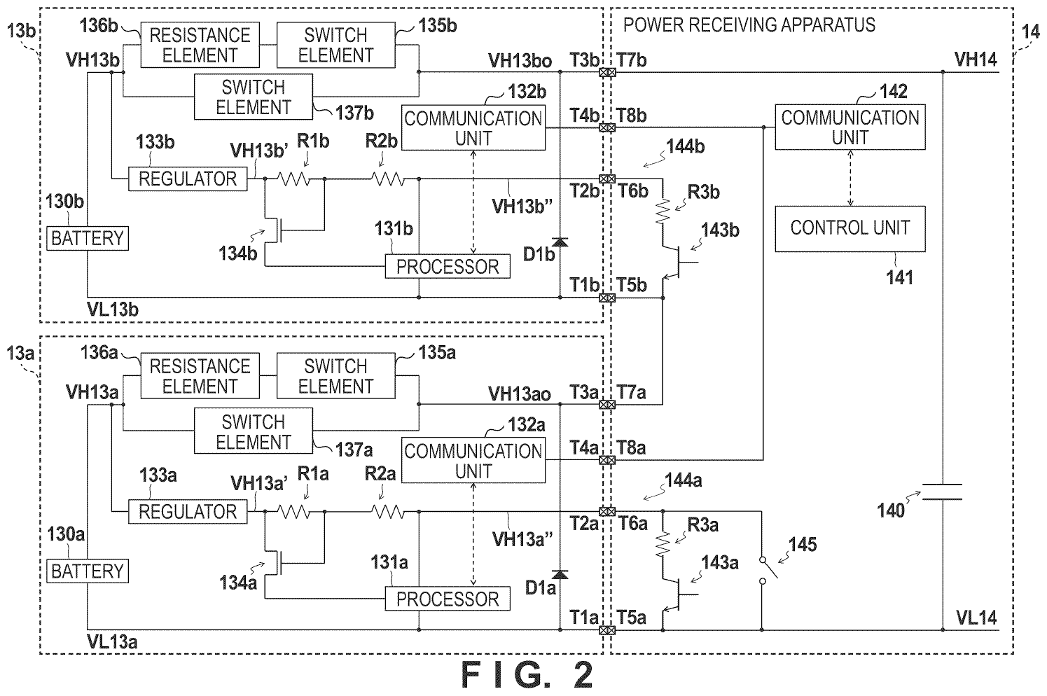

FIG. 2 is a circuit block diagram illustrating a system configuration example of the battery unit 13 and the power receiving apparatus 14. Here, for ease of description, two battery units 13 are arranged in parallel. For distinction, one of them is referred to as “battery unit 13a” and the other is referred to as battery unit 13b″.

### (Configuration Example of Battery Unit)

The battery unit 13a includes a battery (battery body) 130a, a processor 131a, a communication unit 132a, a regulator 133a, a plurality of resistance elements 136a, R1a, and R2a, a plurality of switch elements 134a, 135a, and 137a, and a rectifying element D1a. The battery unit 13a is configured by unitizing these elements 130a and the like, and includes a housing in which terminal groups T1a to T4a configured to electrically connect the battery unit 13a to the power receiving apparatus 14 are provided.

The battery 130a outputs a direct current (DC) voltage of 48 [V] in the present embodiment. The battery 130a typically can be configured by connecting a plurality of battery cells in series, but may be configured by a single battery cell. In the figure, a positive electrode-side power supply line of the battery 130a is represented by a line VH13a, and a negative electrode-side power supply line thereof is represented by a line VL13a. The power supply line VL13a is electrically connected to the terminal T1a.

Although the details of the processor 131a will be described later, the processor 131a is an electronic component (for example, a semiconductor package) configured to control the power feeding function of the battery 130a. The processor 131a may be a semiconductor device such as an application specific integrated circuit (ASIC) or a programmable logic device (PLD), but may be configured by a central processing unit (CPU) and a memory so as to be able to achieve the same function. That is, the function of the processor 131a can be achieved by either hardware or software.

The communication unit 132a is an electronic component configured to be able to communicate with elements outside the battery unit 13a via the terminal T4a, and enables external communication of the processor 131a by mutual communication with the processor 131a as represented by a broken line in the figure.

The regulator 133a outputs a predetermined voltage (here, 3.3 [V]) to a line VH13a′ based on the voltage (here, 48 [V]) of the power supply line VH13a. The resistance elements R1a and R2a are connected in series between the line VH13a′ and a line VH13a″ electrically connected to the terminal T2a, and although the details thereof will be described later, voltage division based on the resistance ratio is generated at the node between the resistance elements R1a and R2a.

In the present embodiment, a metal oxide semiconductor (MOS) transistor is used as the switch element 134a, and a gate terminal thereof is electrically connected to the node between the resistance elements R1a and R2a. A drain terminal is electrically connected to the line VH13a′, and a source terminal is electrically connected to the processor 131a.

The switch element 135a and the resistance element 136a are connected in series between the power supply line VH13a and a line VH13ao electrically connected to the terminal T3a. The switch element 137a is connected in parallel to the switch element 135a and the resistance element 136a connected in series. That is, the voltage (here, 48 [V]) of the power supply line VH13a can be output from the terminal T3a via the switch element 135a and the resistance element 136a and/or via the switch element 137a. A known transistor withstanding high voltages may be used for the switch elements 135a and 137a.

The rectifying element D1a is disposed such that it includes an anode electrically connected to the line VH13a (terminal T1a) and a cathode electrically connected to the line VH13ao (terminal T3a).

As illustrated in FIG. 2, the battery unit 13b has the same configuration as that of the above-described battery unit 13a, that is, includes an element 130b and the like corresponding to the above-described element 130a and the like. In particular, the battery 130b is configured similarly to the battery 130a; the processor 131b is configured similarly to the processor 131a; the communication unit 132b is configured similarly to the communication unit 132a; and the regulator 133b is configured similarly to the regulator 133a. These are disposed. The resistance elements 136b, R1b, and R2b are configured similarly to the resistance elements 136a, R1a, and R2a, respectively, and the switch elements 134b, 135b, and 137b are configured similarly to the switch elements 134a, 135a, and 137a, respectively. These are disposed. Lines VH13b, VH13bo, VL13b, VH13b′, and VH13b″ in the figure correspond to the VH13a, the VH13ao, the VL13a, the VH13a′, and the VH13a″, respectively. A rectifying element D1b is configured and arranged similarly to the rectifying element D1a. The battery unit 13b includes a housing in which terminal groups T1b to T4b capable of electrically connecting the battery unit 13b to the power receiving apparatus 14 are provided. These terminal groups correspond to the terminal groups T1a to T4a.

### (Configuration Example of Power Receiving Apparatus)

The power receiving apparatus 14 includes a capacitor 140, a control unit 141, a communication unit 142, resistance elements R3a and R3b, switch elements 143a and 143b, and an activation switch 145. The power receiving apparatus 14 is configured by unitizing these elements 140 and the like, and includes a housing in which terminal groups T5a to T8a and T5b to T8b configured to electrically connect the battery units 13a and 13b are provided. The terminal groups T1a to T4a are electrically connected to the terminal groups T5a to T8a, respectively, and the terminal groups T1b to T4b are electrically connected to the terminal groups T5b to T8b, respectively.

Although the details will be described later, the terminal groups T5a to T8a, the resistance element R3a, and the switch element 143a form a connection portion 144a that can electrically connect the battery unit 13a. The terminal groups T5b to T8b, the resistance element R3b, and the switch element 143b form a connection portion 144b that can electrically connect the battery unit 13b.

The capacitor 140 is provided between a line VH14 electrically connected to the terminal T7b and a line VL14 electrically connected to the terminal T5a, and can hold a voltage received from the battery unit 13a (and 13b).

The control unit 141 controls the entire power receiving apparatus 14, and can communicate with each of the processors 131a and 131b, for example, although the details will be described later. The function of the control unit 141 can be achieved by either hardware or software similarly to the processor 131a and the like. The control unit 141 further has a function as the PDU, and can convert the voltage held by the capacitor 140 into a predetermined mode and supply the converted voltage to the electric motor 12.

The communication unit 142 is an electronic component configured to be able to communicate with the communication units 132a and 132b via the terminals T8a and T8b, respectively, and enables external communication of the control unit 141 by mutual communication with the control unit 141 as represented by a broken line in the figure. Such a connection aspect can also provide mutual communication between the communication units 132a and 132b. This also allows, for example, the processor 131a of the battery unit 13a to output an instruction signal (or an instruction command) to the processor 131b of the battery unit 13b to directly control the power feeding function of the battery unit 13b.

The resistance element R3a and the switch element 143a are connected in series between the terminals T5a and T6a. In the present embodiment, a bipolar transistor is used as the switch element 143a, and a base terminal can be controlled by the control unit 141. With such a configuration, the connection portion 144a capable of electrically connecting the battery unit 13a is formed. For example, when the switch element 143a is brought into a conductive state, a predetermined voltage is generated in the line VH13a″. This voltage may be substantially determined by the voltage between the lines VH13a′ and VL13a and the resistance values of the resistance elements R1a, R2a, and R3a.

Similarly, the resistance element R3b and the switch element 143b are connected in series between the terminals T5b and T6b. In the present embodiment, a bipolar transistor is used as the switch element 143b, and a base terminal can be controlled by the control unit 141. With such a configuration, the connection portion 144b that can electrically connect the battery unit 13b is formed.

In the present embodiment, the activation switch 145 is connected in parallel to the resistance element R3a and the switch element 143a connected in series. In the present embodiment, the activation switch 145 is a press-type switch. That is, the activation switch 145 is in a conductive state while being pressed, and is in a non-conductive state while not being pressed. When the activation switch 145 is pressed (is in a conductive state), a voltage determined by the voltage between the lines VH13a′ and VL13a and the resistance values of the resistance elements R1a and R2a is generated between the lines VH13a″ and VL13a.

In the present embodiment, the activation switch 145 is described as a part of the power receiving apparatus 1, but may be provided separately from the apparatus 1. For example, the activation switch 145 may be externally attached to an electric path (that is, between the connection portion between the terminals T1a and T5a and the connection portion between the terminals T2a and T6a) between the battery unit 13a and the connection portion 144a.

With such a configuration, the battery units 13a and 13b can be electrically connected to the power receiving apparatus 14 (to the connection portions 144a and 144b, respectively). Although the details will be described later, in the present system configuration, the battery units 13a and 13b are connected in series and electrically connected to the power receiving apparatus 14. As described above, the battery units 13a and 13b have the same configurations, whereby they can be replaced with each other, or one or both of them can be replaced with other battery unit (new/charged battery unit) having the same configuration.

### (Activation Mechanism)

In the present system configuration, the power supply lines VL13a and VL14 (the terminals T1a and T5a) are fixed/grounded to the ground voltage (0 [V]). The voltage described below generally indicates a potential difference generated between two elements (terminal and node and the like), but for ease of description, may indicate a potential difference from this ground voltage.

Before the activation (stop state) of the work machine 1, both the battery units 13a and 13b and the power feeding apparatus 14 are in a resting state. That is, the processors 131a and 131b, the communication units 132a and 132b, the control unit 141, and the communication unit 142 are all in a resting state, and the switch elements 135a, 137a, 143a, 135b, 137b, and 143b, and the activation switch 145 are all in a non-conductive state.

The user (the owner of the work machine 1 or the like) presses the activation switch 145 to achieve the activation of the work machine 1. The activation switch 145 is brought into a conductive state by pressing, whereby the line VH13a″ (terminals T2a and T6a) has the same potential as that of the power supply line VL13a (terminals T1a and T5a). That is, the line VH13a″ (terminals T2a and T6a) is grounded. As a result, voltage division (defined as voltage Vdiv1) based on the voltage (3.3 [V]) between the lines VH13a′ and VL13a and the resistance ratio of the resistance elements R1a and R2a, that is,

$$Vdiv 1 = VDD \times R 2 a / ( R 1 a + R 2 a ) , \qquad [ Expression 1 ]$$

VDD: voltage between lines VH13a′ and VL13a (3.3 [V]),
R1a: resistance value of resistance element R1a,
R2a: resistance value of resistance element R2a,
is generated at the node between the resistance elements R1a and R2a.

As a result, the voltage Vdiv1 is applied to the gate terminal of a MOS transistor which is the switch element 134a, and accordingly, the switch element 134a is brought into a conductive state, and a voltage VDD supplied to the drain terminal is supplied to the processor 131a via the source terminal. In response, the processor 131a is brought into an active state.

Then, the processor 131a in the active state brings the switch element 135a into a conductive state. As a result, the voltage (48 [V]) of the power supply line VH13a is transmitted to the line VH13ao via the resistance element 136a and the switch element 135a, and is output from the battery unit 13a via the terminal T3a. At substantially the same time (alternatively, at the timing before/after the outputting), the processor 131a brings the communication unit 132a into an active state.

The voltage output from the battery unit 13a is transmitted to the line VH14 via the terminals T7a and T5b of the power receiving apparatus 14, via the terminal T1b, the rectifying element D1b, and the terminal T3b of the battery unit 13b, and via the terminal T7b of the power receiving apparatus 14. As a result, the capacitor 140 is charged, and the voltage between the lines VH14 and VL14 increases with the lapse of time.

After a lapse of a predetermined time from the start of charging of the capacitor 140, the processor 131a further brings the switch element 137a into a conductive state. At this time, the processor 131a may maintain the switch element 135a in a conductive state or a non-conductive state. As a result, it is possible to increase the charging speed after the charging is stabilized while suppressing a steep potential difference that may be generated after the start of the charging.

When the voltage between the lines VH14 and VL14 is sufficiently increased (up to the voltage (48 [V]) of the power supply line VH13a) by charging the capacitor 140, the control unit 141 is accordingly brought into an active state, and at substantially the same time, the communication unit 142 is also brought into an active state.

Then, the control unit 141 in the active state brings the switch elements 143a and 143b into a conductive state. After the pressing of the activation switch 145 is released, in the battery unit 13a, voltage division (defined as voltage Vdiv2) based on the voltage between the lines VH13a′ and VL13a and the resistance ratio of the resistance elements R1a, R2a, and R3a is performed, that is,

$$Vdiv 2 = VDD \times R 3 a / ( R 1 a + R 2 a + R 3 a ) , \qquad [ Expression 2 ]$$

R3a: resistance value of resistance element R3a,
is generated between the lines VH13a″ and VL13a by the switch element 143a in the conductive state.

Meanwhile, in the battery unit 13b, voltage division (defined as voltage Vdiv3) based on the voltage (3.3 [V]) between the line VH13b′ and the line VL13b and the resistance ratio of the resistance elements R1b, R2b, and R3b, that is,

$$Vdiv 3 = VDD \times ( R 2 b + R 3 b ) / ( R 1 b + R 2 b + R 3 b ) , \qquad [ Expression 3 ]$$

VDD: voltage between lines VH13b′ and VL13b (3.3 [V]),
R1b: resistance value of resistance element R1b,
R2b: resistance value of resistance element R2b,
R3b: resistance value of resistance element R23,
are generated between the node between the resistance elements R1b and R2b and the line VL13b by the switch element 143b in the conductive state.

As a result, the voltage Vdiv3 is applied to the gate terminal of a MOS transistor which is the switch element 134b, and accordingly, the switch element 134b is brought into a conductive state, and a voltage VDD supplied to the drain terminal is supplied to the processor 131b via the source terminal. In response, the processor 131b is brought into an active state, and at substantially the same time, the communication unit 132b is also brought into an active state.

Similarly, voltage division (defined as voltage Vdiv4) based on the voltage between the lines VH13b′ and VL13b and the resistance ratio of the resistance elements R1b, R2b, and R3b, that is,

$$Vdiv 4 = VDD \times R 3 b / ( R 1 b + R 2 b + R 3 b ) , \qquad [ Expression 4 ]$$

is generated between the lines VH13b″ and VL13b.

Although the details will be described later, the processor 131a can detect the voltage of the line VH13a″, which makes it possible to determine that the battery unit 13a is electrically connected to the connection portion 144a. Similarly, the processor 131b can detect the voltage of the line VH13b″, which makes it possible to determine that the battery unit 13b is electrically connected to the connection portion 144b.

Then, the processor 131b controls the switch elements 135b and 137b in the same procedure as that of the processor 131a, and outputs the voltage of the power supply line VH13b connected to the battery 130b via the line VH13bo. The voltage between the power supply lines VH13b and VL13b is 48 [V].

As can be seen from FIG. 2, the battery units 13a and 13b are connected in series and electrically connected to the power receiving apparatus 14. Therefore, a voltage (total 96 [V]) obtained by adding the output voltage (48 [V]) of the battery 130b to the output voltage (48 [V]) of the battery 130a is supplied to the power receiving apparatus 14. As described above, the work machine 1 can be brought into an operating state.

In order to bring the work machine 1 in the operating state into a resting state again, the activation switch 145 may be pressed again. When the activation switch 145 is pressed again, the processor 131a detects that the line VH13a″ is grounded to bring the battery unit 13a into a resting state. Prior to this, the processor 131a can also output an instruction signal for instructing the battery unit 13b and the power receiving apparatus 14 to be brought into a stop state by external communication via the communication unit 132a.

When the battery unit 13a and/or 13b are/is removed while the work machine 1 is in an operating state, mutual communication via the corresponding communication unit 132a and/or 132b is interrupted. At substantially the same time, the voltage (the voltage between the lines VH13a″ and VL13a and/or the voltage between the lines VH13b″ and VL13b) supplied to the processor 131a and/or 131b is 3.3 [V], whereby the processor 131a and/or 131b can detect that the battery unit 13a and/or 13b are/is removed. The voltage of the terminal T6a and/or T6b is a floating state in the power receiving apparatus 14, whereby the control unit 141 can detect that the removal is performed.

That is, both the processors 131a and 131b and the control unit 141 can detect that the removal is performed based on the communication result by the communication unit 132a or the like and the voltage supplied to the processor 131a or the like. As a result, for example, when the battery unit 13a (13b) is removed, the processor 131b (131a) can bring the battery unit 13b (13a) into a resting state by itself, and the control unit 141 can bring the power receiving apparatus 14 into a resting state by itself.

By referring to the communication results among the communication units 132a, 132b, and 142, in the case where the mutual communication is interrupted even though the battery unit 13a and/or 13b are/is not removed, this can be detected. For example, when the battery units 13a and 13b are not removed, the voltage supplied to the processors 131a and 131b and the voltage received by the power receiving apparatus 14 (the voltage of the terminals T6a and T6b) do not fluctuate (the value when the work machine 1 is in an operating state remains). Nevertheless, when a desired communication result cannot be obtained, the mutual communication can be said to be interrupted, whereby the processors 131a and 131b and the control unit 141 can detect that an unpredicted communication failure is generated among the communication units 132a, 132b, and 142.

Alternatively, in the case where the mutual communication is not interrupted even though the battery unit 13a and/or 13b are/is removed, this can be detected. As described above, when the battery unit 13a and/or 13b are/is removed, the voltage supplied to the processor 131a and/or 131b is 3.3 [V], and the voltage of the terminal T6a and/or T6b is in a floating state in the power receiving apparatus 14. Nevertheless, when the mutual communication is continued, an unpredicted operation can be said to occur in the power receiving apparatus 14, and the processors 131a and 131b and the control unit 141 can detect this.

It is sufficient that whether or not the battery units 13a and/or 13b are/is appropriately electrically connected can be detected on the side of the processors 131a and 131b and the control unit 141, and the above-described removal includes removal not intended by the user, such as a contact failure.

### (Control of Power Feeding Function by Processor)

As described above, the communication units 132a and 132b and the communication unit 142 enable mutual communication between the processors 131a and 131b and the control unit 141. As a result, for example, based on a load situation or the like applied to the battery unit 13a and/or 13b, it is possible to control the power feeding function thereof by itself/themselves.

Meanwhile, in the present system configuration, the power supply lines VL13a and VL14 (the terminals T1a and T5a) are fixed to the ground voltage. In contrast, in the present system configuration, the power supply line VL13b associated as the ground line in the battery unit 13b has a voltage (48 [V] in the present embodiment) higher than the ground voltage when the work machine 1 is used (in the operating state of the work machine 1).

In general, in a system in which a plurality of power supply systems are present, a system configuration is made on the basis of the ground voltage or a voltage closest thereto in order to ensure operation stability on the system. This similarly applies to the present system configuration, and for example, even if the battery unit 13b is an active state while the battery unit 13a is in a resting state, the circuit constituting the battery unit 13b is not appropriately operated. Therefore, for example, a superior-subordinate relationship such as master/slave (parent/child) may be provided between the processors 131a and 131b and the control unit 141, and priority may be incidentally set to these instruction signals.

As an example, a case where the control unit 141 is set as the master and the processors 131a and 131b are set as the slave will be considered. For example, it may be necessary to bring the battery unit 13a into a resting state while the work machine 1 is in an operating state. In this case, the processor 131a can output a resting instruction to the battery unit 13b (processor 131b) and the power receiving apparatus 14 (control unit 141) before bringing the battery unit 13a into a resting state. By setting this resting instruction to have higher priority than that of mutual communication between the battery unit 13b and the power receiving apparatus 14, both the processors 131a and 131b and the control unit 141 can be appropriately brought into a resting state (for example, in a predetermined order).

As other example, it is also possible to set the processor 131a as the master and the processor 131b and the control unit 141 as the slave, and in this case, the same can be achieved.

In short, in the present system configuration, the battery units 13a and 13b include the processors 131a and 131b that can control the power feeding function by themselves, respectively, and perform mutual communication with the power receiving apparatus 14 (control unit 141). Meanwhile, in order to secure operation stability on the system, it may be required to provide a superior-subordinate relationship between the processors 131a and 131b and the control unit 141, and to provide priority to the instruction systems.

Here, as described above, the battery units 13a and 13b have the same configurations, and may be electrically connected to any of the connection portions 144a and 144b. Therefore, in order to be able to set the priority of the superior-subordinate relationship and the instruction system described above, the processor 131a (131b) is required to be able to determine by itself which of the connection portions 144a and 144b the battery unit 13a (13b) is electrically connected to. This is preferably achieved with a relatively simple configuration without unnecessarily increasing the number of terminals or complicating the structures of the connection portions 144a and 144b.

Therefore, in the present embodiment, the resistance elements R3a and R3b are provided so that their resistance values are different from each other. The battery units 13a and 13b have the same configurations, whereby the resistance elements R1a and R1b have the same resistance values, and the resistance elements R2a and R2b have the same resistance values. That is,

$$R 1 a = R 1 b , \qquad [ Expression 5 ]$$

$$R 2 a = R 2 b , and$$

$$R 3 a \neq R 3 b$$

are set.

As described above (see [Expression 2] and [Expression 4]), the voltage Vdiv2 applied between the lines VH13a″ and VL13a is

$$Vdiv 2 = VDD \times R 3 a / ( R 1 a + R 2 a + R 3 a ) ,$$

and the voltage Vdiv4 applied between the lines VH13b″ and VL13b is

$$Vdiv 4 = VDD \times R 3 b / ( R 1 b + R 2 b + R 3 b ) .$$

$$According to the above [ Expression 5 ] , Vdiv 2 \neq Vdiv 4 ,$$

is set.

Therefore, the processor 131a (131b) can determine which of the connection portions 144a and 144b the battery unit 13a (13b) is electrically connected to, when the line VH13a″ (VH13b″) detects any of the voltages Vdiv2 and Vdiv4. In the present system configuration, the processor 131a detects the voltage Vdiv2 of the line VH13a″, whereby the processor 131a can determine that the battery unit 13a is electrically connected to the connection portion 144a. The processor 131b detects the voltage Vdiv4 of the line VH13b″, whereby the processor 131b can determine that the battery unit 13b is electrically connected to the connection portion 144b.

Therefore, according to the present embodiment, the control of the individual power feeding functions of the battery units 13a and 13b can be appropriately achieved while the operation stability on the system is secured. This is realized by the configurations of the connection portions 144a and 144b while the battery units 13a and 13b have the same configurations. In the present embodiment, the connection portions 144a and 144b include resistance elements R3a and R3b configured to be able to receive a DC voltage from the battery units 13a and 13b, respectively, and allowing a current corresponding to the DC voltage to flow. The resistance elements R3a and R3b have resistance values different from each other, whereby, as a result, the voltages supplied to the processors 131a and 131b can be made different from each other. Therefore, the above can be said to be achievable with a relatively simple configuration. As other embodiment, alternatively/incidentally, the switch elements 143a and 143b may be configured to have on-resistances different from each other, whereby the same can be achieved.

In order to ensure the operation stability on the system, the activation switch 145 may be provided at the ground voltage or a power supply system closest thereto. In the present embodiment, the activation switch 145 is provided for the connection portion 144a located on the ground voltage side among the connection portions 144a and 144b. As a result, an unpredicted voltage is not applied to the processor 131a at the time of activation. Therefore, according to the present embodiment, the control of the individual power feeding functions of the battery units 13a and 13b can be said to be more appropriately achievable.

In the present embodiment, the number of the battery units 13 is 2, but the contents of the embodiment can also be applied to a case where the number of the battery units 13 is 3 or more. In the present embodiment, the aspect in which the plurality of battery units 13 are electrically connected to the power receiving apparatus 14 in series connection has been exemplified, but the contents of the embodiment can also be applied to a case where the connection aspect thereof is parallel connection.

As described above, according to the present embodiment, each of the plurality of (two in the embodiment) battery units 13a and 13b includes the processors 131a and 131b configured to control the power feeding function. The power receiving apparatus 14 includes a plurality of (two in the embodiment) connection portions 144a and 144b that can electrically connect the battery units 13a and 13b, respectively. The connection portions 144a and 144b are configured such that voltages supplied to the corresponding processors 131a and 131b have different values when the battery units 13a and 13b are electrically connected to the connection portions. This can be appropriately achieved, for example, by configuring the resistance elements R3a and R3b with resistance values different from each other. According to the present embodiment, the processor 131a (131b) can detect which of the connection portions 144a and 144b the battery unit 13a (13b) is electrically connected to. As a result, the processor 131a (131b) can appropriately control the power feeding function according to the electrically-connected connection portion 144a or 144b.

In the above description, each element has been given a name related to its functional aspect for ease of understanding. Meanwhile, each element is not limited to one having, as a main function, the function described in the embodiment, and may be one having the function as an auxiliary function.

### SUMMARY OF EMBODIMENT

The features of the embodiment can be summarized as follows.

A first aspect relates to a power receiving apparatus (for example, 14). The power receiving apparatus is configured to be able to receive electric power from a plurality of battery units (for example. 13a, 13b) each including a processor (for example, 131a, 131b) configured to control a power feeding function. The power receiving apparatus includes a plurality of connection portions (for example, 144a, 144b) capable of electrically connecting the plurality of battery units. The plurality of connection portions are configured such that voltages supplied to the plurality of processors of the plurality of battery units have different values when the plurality of battery units are electrically connected to the connection portions.

According to such a configuration, in each battery unit, the processor can detect which of the plurality of connection portions the battery unit is electrically connected to, and can appropriately control a power feeding function according to the connection portion.

In a second aspect, each of the plurality of connection portions includes a resistance element (for example. R3a, R3b) configured to be capable of receiving a DC voltage (for example, 48 [V]) from a corresponding battery unit and causing a current corresponding to the DC voltage to flow, and resistance values of the resistance elements are different from each other among the plurality of connection portions.

Such a configuration can relatively easily achieve the first aspect.

In a third aspect, the power receiving apparatus further includes a communication unit (for example, 142) configured to communicate with the plurality of processors, and a control unit (for example, 141) configured to individually control the plurality of processors via the communication unit.

Such a configuration makes it possible to individually control the power feeding function of each battery unit.

In a fourth aspect, the communication unit further enables the plurality of processors to communicate with each other, to allow at least one (for example, 131a) of the plurality of processors to control another processor (for example, 131b).

Such a configuration also makes it possible to cause a certain battery unit to control the power feeding function of the other battery unit.

In a fifth aspect, the communication unit allows the at least one processor to control the other processor based on the voltage supplied by a corresponding connection portion.

Such a configuration makes it possible to appropriately achieve the fourth aspect.

In a sixth aspect, the control unit determines whether or not the plurality of battery units are appropriately electrically connected in the plurality of connection portions, based on a communication result by the communication unit and a voltage supplied to the plurality of processors.

Such a configuration makes it possible to individually determine whether or not the electrical connection of the battery unit is appropriately performed.

In a seventh aspect, the plurality of connection portions are configured such that when the plurality of battery units are electrically connected to the plurality of connection portions, the plurality of battery units are connected in series.

Such a configuration makes it possible to supply a relatively large voltage to the power receiving apparatus.

In an eighth aspect, when a battery unit closest to a ground voltage among the plurality of battery units is defined as a first battery unit (for example, 13a), and a connection portion corresponding to the first battery unit among the plurality of connection portions is defined as a first connection portion (for example, 144a), the power receiving apparatus further includes an activation switch (for example, 145) provided for the first connection portion and configured to activate the processor of the first battery unit.

According to such a configuration, when the processor is activated, an unpredicted voltage is not applied to the processor.

A ninth aspect relates to an electric power unit (for example, PU). The electric power unit includes: the power receiving apparatus (for example, 14); and an electric motor (for example, 12) that generates motive power based on electric power received from the plurality of battery units by the power receiving apparatus.

That is, the power receiving apparatus described above can be applied to a known electric power unit.

A tenth aspect relates to a work machine (for example, 1). The work machine includes: the electric power unit (for example, PU); and a work mechanism (for example, 11) capable of executing work based on the motive power of the electric motor.

That is, the above-described electric power unit can be applied to a known work machine.

A 11th aspect relates to a battery unit (for example, 13a). The battery unit is configured to be electrically connectable to any of a plurality of connection portions (for example, 144a, 144b) included in a power receiving apparatus (for example, 14). The plurality of connection portions are configured such that voltages supplied to a plurality of battery units have different values when the plurality of battery units are electrically connected to the connection portions. The battery unit includes a processor (for example, 131a) capable of controlling a power feeding function based on a voltage supplied by a connection portion to which the battery unit is electrically connected.

According to such a configuration, in each battery unit, the processor can detect which of the plurality of connection portions the battery unit is electrically connected to, and can appropriately control a power feeding function according to the connection portion.

In a 12th aspect, each of the plurality of connection portions includes a resistance element (for example, R3a, R3b) configured to be capable of receiving a DC voltage (for example, 48 [V]) from a corresponding battery unit and causing a current corresponding to the DC voltage to flow. Resistance values of the resistance elements are different from each other among the plurality of connection portions. The battery unit is configured to be capable of outputting the DC voltage.

Such a configuration can relatively easily achieve the first aspect.

In a 13th aspect, the battery unit further includes a communication unit (for example, 132a) configured to communicate with the power receiving apparatus via the connection portion.

Such a configuration makes it possible to individually control the power feeding function of each battery unit.

In a 14th aspect, the communication unit is further configured to be communicable with another battery unit (for example, 13b), to allow the processor to control another processor (for example, 131b) included in the other battery unit.

Such a configuration also makes it possible to cause a certain battery unit to control the power feeding function of the other battery unit.

In a 15th aspect, the communication unit allows the processor to control the other processor based on the voltage supplied by the connection portion.

Such a configuration makes it possible to appropriately achieve the 14th aspect.

In a 16th aspect, the battery unit and the other battery unit are connected in series when each of the battery unit and the other battery unit is electrically connected to the corresponding connection portion.

Such a configuration makes it possible to supply a relatively large voltage to the power receiving apparatus.

A 17th aspect relates to an electric power unit (for example, PU). The electric power unit includes: the battery unit (for example, 13a); the power receiving apparatus; and an electric motor (for example, 12) that generates motive power based on electric power received from the battery unit.

That is, the above-described battery unit can be applied to a known electric power unit.

A 18th aspect relates to a work machine. The work machine includes: the electric power unit (for example, PU); and a work mechanism (for example, 11) capable of executing work based on the motive power of the electric motor.

That is, the above-described electric power unit can be applied to a known work machine.

The invention is not limited to the foregoing embodiments, and various variations/changes are possible within the spirit of the invention.

1. A power receiving apparatus configured to be able to receive electric power from a plurality of battery units each including a processor configured to control a power feeding function,
the power receiving apparatus comprising a plurality of connection portions capable of electrically connecting the plurality of battery units, wherein
the plurality of connection portions are configured such that voltages supplied to the plurality of processors of the plurality of battery units have different values when the plurality of battery units are electrically connected to the connection portions.

2. The power receiving apparatus according to claim 1, wherein
each of the plurality of connection portions includes a resistance element configured to be capable of receiving a DC voltage from a corresponding battery unit and causing a current corresponding to the DC voltage to flow, and
resistance values of the resistance elements are different from each other among the plurality of connection portions.

3. The power receiving apparatus according to claim 1, further comprising:
a communication unit configured to communicate with the plurality of processors; and
a control unit configured to individually control the plurality of processors via the communication unit.

4. The power receiving apparatus according to claim 3, wherein
the communication unit further enables the plurality of processors to communicate with each other, to allow at least one of the plurality of processors to control other processor.

5. The power receiving apparatus according to claim 4, wherein
the communication unit allows the at least one processor to control the other processor based on the voltage supplied by a corresponding connection portion.

6. The power receiving apparatus according to claim 3, wherein
the control unit determines whether or not the plurality of battery units are appropriately electrically connected in the plurality of connection portions, based on a communication result by the communication unit and a voltage supplied to the plurality of processors.

7. The power receiving apparatus according to claim 1, wherein
the plurality of connection portions are configured such that when the plurality of battery units are electrically connected to the plurality of connection portions, the plurality of battery units are connected in series.

8. The power receiving apparatus according to claim 7, wherein
when a battery unit closest to a ground voltage among the plurality of battery units is defined as a first battery unit, and a connection portion corresponding to the first battery unit among the plurality of connection portions is defined as a first connection portion, the power receiving apparatus further includes an activation switch provided for the first connection portion and configured to activate the processor of the first battery unit.

9. An electric power unit comprising:
the power receiving apparatus according to claim 1; and
an electric motor that generates motive power based on electric power received from the plurality of battery units by the power receiving apparatus.

10. A work machine comprising:
the electric power unit according to claim 9; and
a work mechanism capable of executing work based on the motive power of the electric motor.

11. A battery unit configured to be electrically connectable to any of a plurality of connection portions included in a power receiving apparatus, wherein
the plurality of connection portions are configured such that voltages supplied to a plurality of battery units have different values when the plurality of battery units are electrically connected to the connection portions, and
the battery unit includes a processor capable of controlling a power feeding function based on a voltage supplied by a connection portion to which the battery unit is electrically connected.

12. The battery unit according to claim 11, wherein
each of the plurality of connection portions includes a resistance element configured to be capable of receiving a DC voltage from a corresponding battery unit and causing a current corresponding to the DC voltage to flow,
resistance values of the resistance elements are different from each other among the plurality of connection portions, and
the battery unit is configured to be capable of outputting the DC voltage.

13. The battery unit according to claim 11, further comprising a communication unit configured to communicate with the power receiving apparatus via the connection portion.

14. The battery unit according to claim 13, wherein
the communication unit is further configured to be communicable with another battery unit, to allow the processor to control another processor included in the other battery unit.

15. The battery unit according to claim 14, wherein
the communication unit allows the processor to control the other processor based on the voltage supplied by the connection portion.

16. The battery unit according to claim 14, wherein
the battery unit and the other battery unit are connected in series when each of the battery unit and the other battery unit is electrically connected to the connection portion that corresponds.

17. An electric power unit comprising:
the battery unit according to claim 11;
the power receiving apparatus; and
an electric motor that generates motive power based on electric power received from the battery unit.

18. A work machine comprising:
the electric power unit according to claim 17; and
a work mechanism capable of executing work based on the motive power of the electric motor.
